(19) United States
(12) Patent Application Publication
(10) Pub. No.: US 2014/0184621 A1
(43) Pub. Date: Jul. 3, 2014

(54) DISPLAY APPARATUS INCLUDING DUAL ACTUATION AXIS ELECTROMECHANICAL SYSTEMS LIGHT MODULATORS

(71) Applicant: PIXTRONIX, INC., San Diego, CA (US)

(72) Inventors: Timothy J. Brosnihan, San Diego, CA (US); Joyce H. Wu, Somerville, MA (US); Mark B. Andersson, Northborough, MA (US); Jasper Lodewyk Steyn, Cupertino, CA (US)

(73) Assignee: Pixtronix, Inc., San Diego, CA (US)

(21) Appl. No.: 13/829,254

(22) Filed: Mar. 14, 2013

Related U.S. Application Data
(60) Provisional application No. 61/746,881, filed on Dec. 28, 2012.

(51) Int. Cl. G02B 26/02; G09G 5/00

(52) U.S. Cl. CPC G02B 26/02; G09G 5/003
USPC 345/520; 359/227; 359/230

(57) ABSTRACT

This disclosure provides systems, methods and apparatus for modulating light to form an image on a display. A light modulator in the display may include a substrate, a shutter, a first actuator and a second actuator. The shutter can be configured to selectively obstruct an optical path through the substrate. The first actuator can be configured to move the shutter in a first direction along a first axis in a plane substantially parallel to a plane defined by the substrate, thereby moving the shutter from a first state to a second state. The second actuator can be configured to move the shutter in a second direction along a second axis. The second axis can be substantially orthogonal to the first axis and also within a plane parallel to the substrate. In some implementations, moving the shutter along the second axis moves the shutter into a third state.

### CROSS-REFERENCE TO RELATED APPLICATIONS

This patent application claims priority to U.S. Provisional Patent Application No. 61/746,881, filed on Dec. 28, 2012, entitled “Display Apparatus Including Dual Actuation Axis Electromechanical Systems Light Modulators.” The disclosure of the prior application is considered part of and is incorporated by reference in this patent application.

### TECHNICAL FIELD

This disclosure relates to the field of displays, and in particular, to microelectromechanical systems (MEMS) displays including multi-state light modulators having multiple axes of movement.

### DESCRIPTION OF THE RELATED TECHNOLOGY

Some electromechanical systems (EMS)-based light modulators can effectively modulate light in a binary fashion, switching between light and dark states. For example, EMS-based shutters can rapidly switch between light transmissive and light blocking states. However, there are few EMS-based light modulators that can reliably achieve discrete partially transmissive states between the fully dark and fully light states.

Thus, displays incorporating EMS-based light modulators tend to generate different gray scale values using principles of time division by driving the light modulators into light or dark states in a series of subframes. Even if such subframes are weighted, such displays may still need to generate a large number of subframes per image frame to obtain the level of grayscale granularity desired.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a substrate, a shutter, a first actuator and a second actuator. The shutter is positioned adjacent to the substrate and is configured to selectively obstruct an optical path through the substrate. The first actuator is mechanically coupled to a first end of the shutter and is configured for moving the shutter in a first direction along a first axis in a plane substantially parallel to a plane defined by the substrate, thereby moving the shutter from a first state to a second state. The second actuator is positioned adjacent the shutter and is configured to move the shutter in a second direction along a second axis. The second axis is substantially orthogonal to the first axis and also is within a plane substantially parallel to the plane defined by the substrate. Moving the shutter along the second axis moves the shutter into a third state. In some implementations, the second actuator includes an electrode, spaced apart from and mechanically separated from the shutter.

In some implementations, the apparatus includes a third actuator. The third actuator may be mechanically coupled to the shutter and configured to move the shutter in a third direction opposite the first direction along the first axis, thereby moving the shutter into the first state. In some other implementations, the apparatus includes a spring, which is mechanically coupled to the shutter to apply a restoring force to the shutter in a third direction opposite the first direction along the first axis, for moving the shutter back into the first state.

In some other implementations, the third actuator may include an actuator which is spaced apart from and mechanically separated from the shutter on a side of the shutter opposite the second actuator for moving the shutter into a fourth state. In some implementations, the electrode of the second actuator spaced apart from the shutter is spaced a first distance from the shutter, and the electrode of the third actuator spaced apart from the shutter is spaced a second distance from the shutter.

In some implementations, the first state is a light transmissive state, the second state is a light blocking state in which the shutter obstructs the optical path through the substrate, and the third state comprises a partially light transmissive state in which the shutter only partially obstructs the optical path. In some implementations, in the partially light transmissive state, the shutter blocks one of about 25%, about 33%, or about 50% of the light in the optical path.

In some implementations, the first actuator is coupled to the shutter by a compliant beam, which includes an expandable portion. In some other implementations, the shutter includes at least one surface that is perpendicular to the plane of the substrate. In some such implementations, the surface of the shutter perpendicular to the plane of the substrate may form a side of the perimeter of the shutter, and the shutter serves as an electrode of the second actuator.

In some implementations, the shutter, the first actuator, and the second actuator form a portion of a display element, and the apparatus includes a display including an array of display elements. The apparatus also may include a processor, which is configured to communicate with the display and to process image data, and a memory device that is configured to communicate with the processor. In some implementations, the apparatus includes a driver circuit configured to send at least one signal to the display, and the controller is further configured to send at least a portion of the image data to the driver circuit. In some implementations, the apparatus also includes an image source module configured to send the image data to the processor. The image source module can include at least one of a receiver, transceiver, and transmitter. In still some other implementations, the apparatus includes an input device configured to receive input data and to communicate the input data to the processor.

Another innovative aspect of the subject matter described in this disclosure can be implemented in an apparatus that includes a substrate, means for selectively obstructing an optical path through the substrate, means for moving the light obstructing means in a first direction along a first axis in a plane substantially parallel to a plane defined by the substrate, thereby moving the light obstructing means from a first state to a second state, and means for moving the light obstructing means in a second direction along a second axis, thereby moving the light obstructing into a third state. The second axis is substantially orthogonal to the first axis in the plane defined by the substrate.

In some implementations, the apparatus includes means for moving the shutter in a third direction opposite the first direction along the first axis, for moving the light obstructing means back into the first state. In some other implementations, the apparatus includes a restoring means for applying a restoring force to the light obstructing means in a third direction opposite the first direction along the first axis, thereby moving the light obstructing means into the first state. In some other implementations, the apparatus may include means for moving the light obstructing means into a fourth state. The third and fourth states may be distinct partially light obstructing states.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIG. 2 shows a perspective view of an example shutter-based light modulator.

FIG. 3A shows a schematic diagram of an example control matrix.

FIG. 3B shows a perspective view of an example array of shutter-based light modulators connected to the control matrix of FIG. 3A.

FIGS. 4A and 4B show views of an example dual actuator shutter assembly.

FIG. 5 shows a cross sectional view of an example display apparatus incorporating shutter-based light modulators.

FIG. 6 shows a cross sectional view of an example light modulator substrate and an example aperture plate for use in a MEMS-down configuration of a display.

FIGS. 7A-7C show plan views of an example multi-state shutter assembly.

FIG. 7D shows a cross-sectional view of the multi-state shutter assembly shown in FIGS. 7A-7C.

FIGS. 8A-8C show plan views of another example multi-state shutter assembly.

FIG. 9 shows a schematic diagram of an example control matrix.

FIGS. 10A-10C show plan views of another example multi-state shutter assembly.

FIGS. 11A-11D show plan views of another example multi-state shutter assembly.

FIGS. 12A-12D show plan views of another example multi-state shutter assembly.

FIGS. 13 and 14 show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A reliable multi-state light modulator can be formed from a shutter that can be actuated along two axes. In some implementations, a first actuator can drive a shutter in a first direction along a first axis from a light transmissive state to a light obstructing state by moving the shutter over an aperture through which light is transmitted. A second actuator can then drive the shutter in a direction along an orthogonal axis to partially unblock the aperture, allowing some portion of the light to pass, while blocking the remaining light. An opposing third actuator or a spring may be used to return the shutter to a light transmitting position. Such configurations provide three reliably obtainable shutter states.

In some implementations, the first actuator is mechanically coupled to the shutter. The second actuator may include an electrode that is physically separated from the shutter.

In some implementations, a fourth actuator can be positioned on the opposite side of the shutter from the second actuator. In some implementations, the fourth actuator can be positioned a different distance from the shutter than the second actuator. Thus, when the shutter is in the light blocking state, blocking the aperture, the second and fourth actuators can pull the shutter different distances, uncovering the aperture to different degrees. Such implementations provide four reliably obtainable shutter states.

Particular implementations of the subject matter described in this disclosure can be implemented to realize one or more of the following potential advantages. By incorporating an extra side actuator configured to move a shutter along a second axis of motion, a shutter assembly can be configured to enter into at least three states, an open, light-transmissive state, a closed, light obstructing state, and a partially open, partially transmissive state. By including shutter assemblies that can achieve additional states, a display apparatus can form an image using fewer subframes. By adding a second side actuator configured to move a shutter as different distance to the side than the first side actuator, a shutter assembly can enter into a further additional state. This additional state can further reduce the number of subframes a display needs to generate to display an image.

In some implementations, a side actuator can be an electrostatic actuator that includes the shutter as one electrode and one side electrode that is physically separated from the shutter. This side electrode can be a relatively simple planar beam with a primary surface that is normal to the substrate on which the shutter assembly is formed. As such, the side electrode can take up relatively little additional space on the substrate, beyond the space used to displace the shutter when the side electrode is energized. In some implementations, the shutter can include a perimeter sidewall that is proximate and parallel to the side electrode to facilitate the electrostatic interaction between the shutter and the side electrode.

In some other implementations, the side actuator can be similar to the actuators that move the shutter along its primary axis of motion. Such actuators may take up additional space, but tend to require lower voltages to operate.

In some implementations, the actuators that move the shutter along its primary axis of motion include a compliant beam having a folded or curved portion. This portion can open up, allowing the shutter to move a long a second axis towards a side actuator when it is energized, while simultaneously providing a restoring force to assist the shutter moving back to its initial position when the side electrode is de-energized.

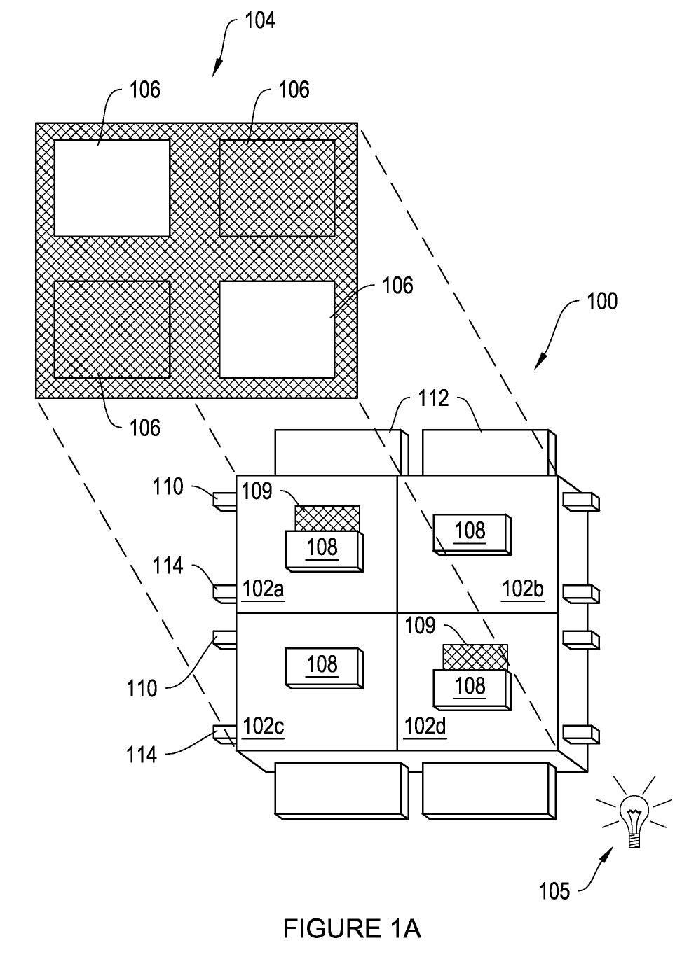

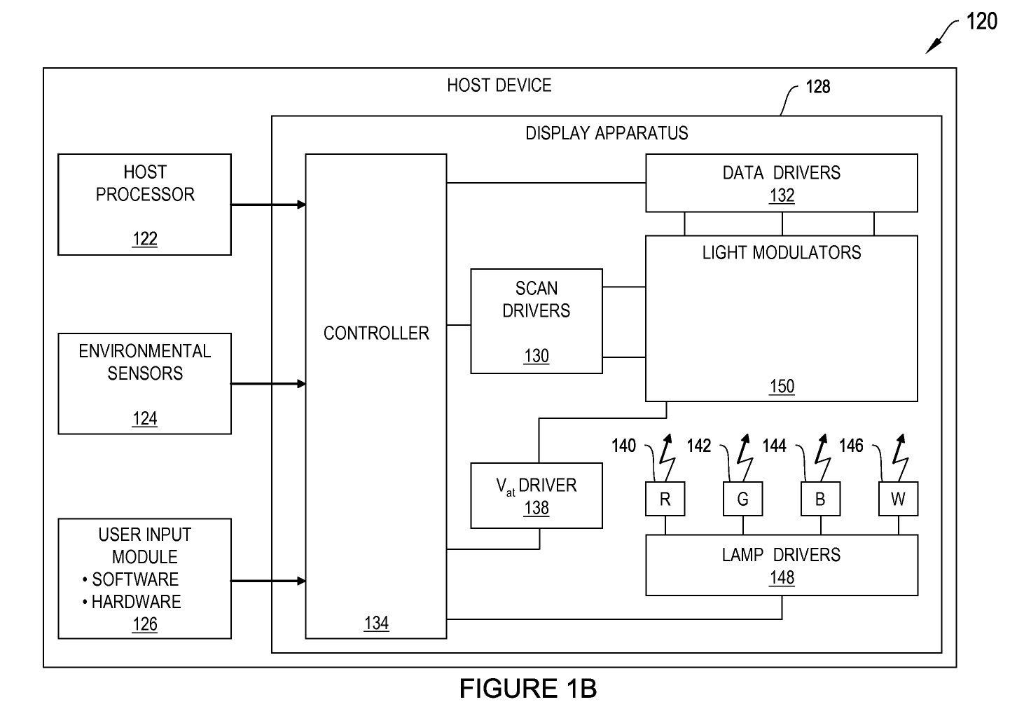

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (for example, interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, for example, transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in sequences, which in some implementations may be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (for example, scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image 104 state is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image 104 state is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

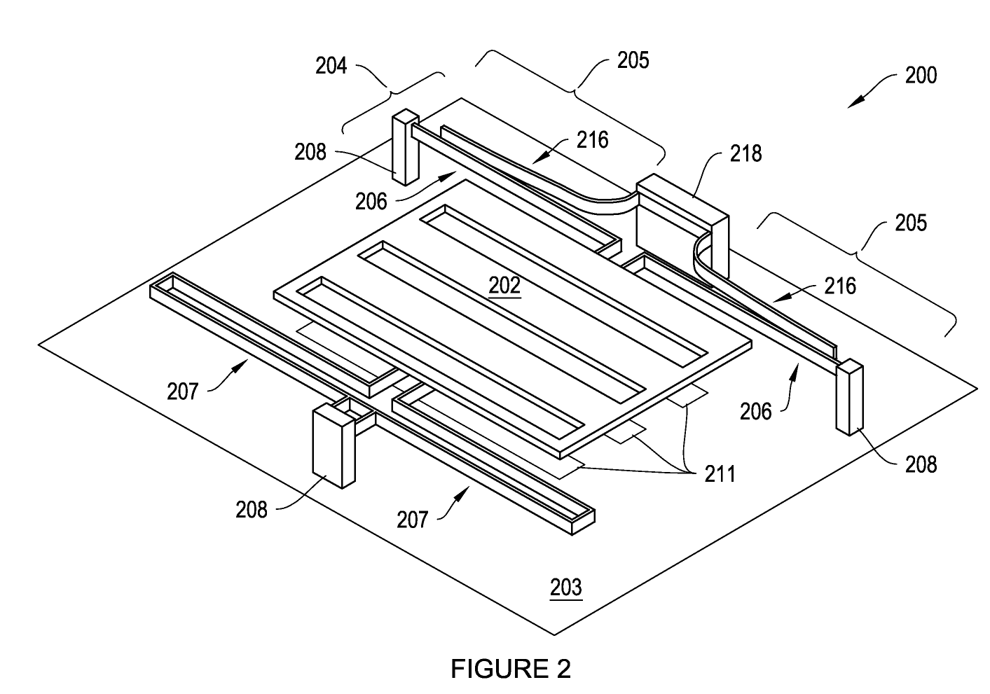

FIG. 2 shows a perspective view of an example shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface 203 includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the aperture holes 211 are formed in a layer of light-blocking material deposited on the substrate 203. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and a separate set of “open” and “closed” electrodes for moving the shutter into either an open or a closed state.

There are a variety of methods by which an array of shutters and apertures can be controlled via a control matrix to produce images, in many cases moving images, with appropriate luminance levels. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

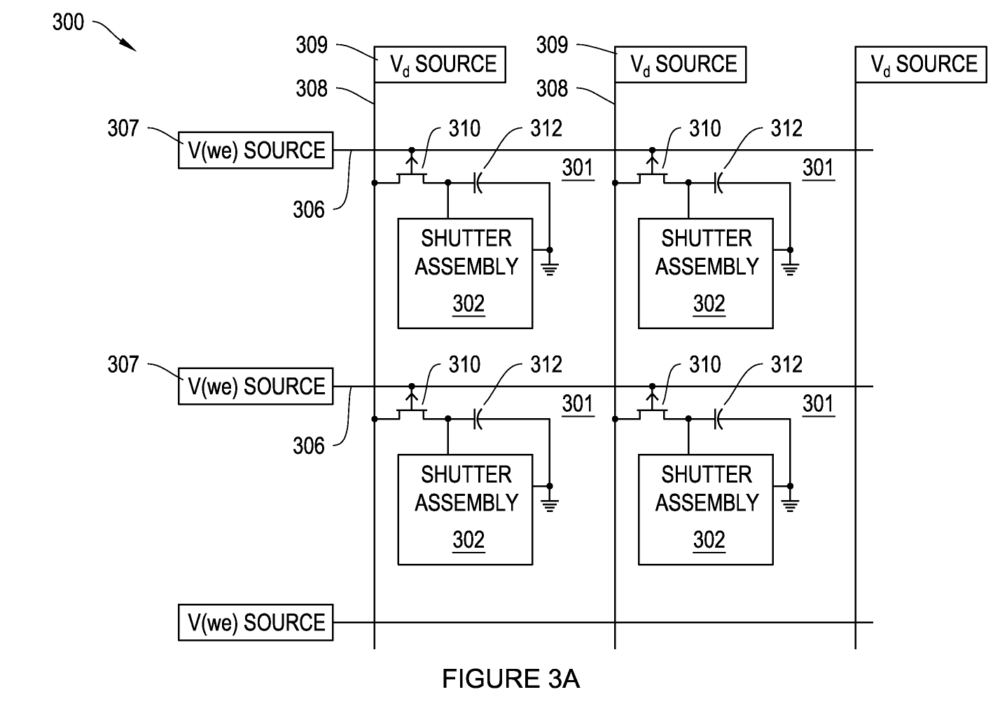

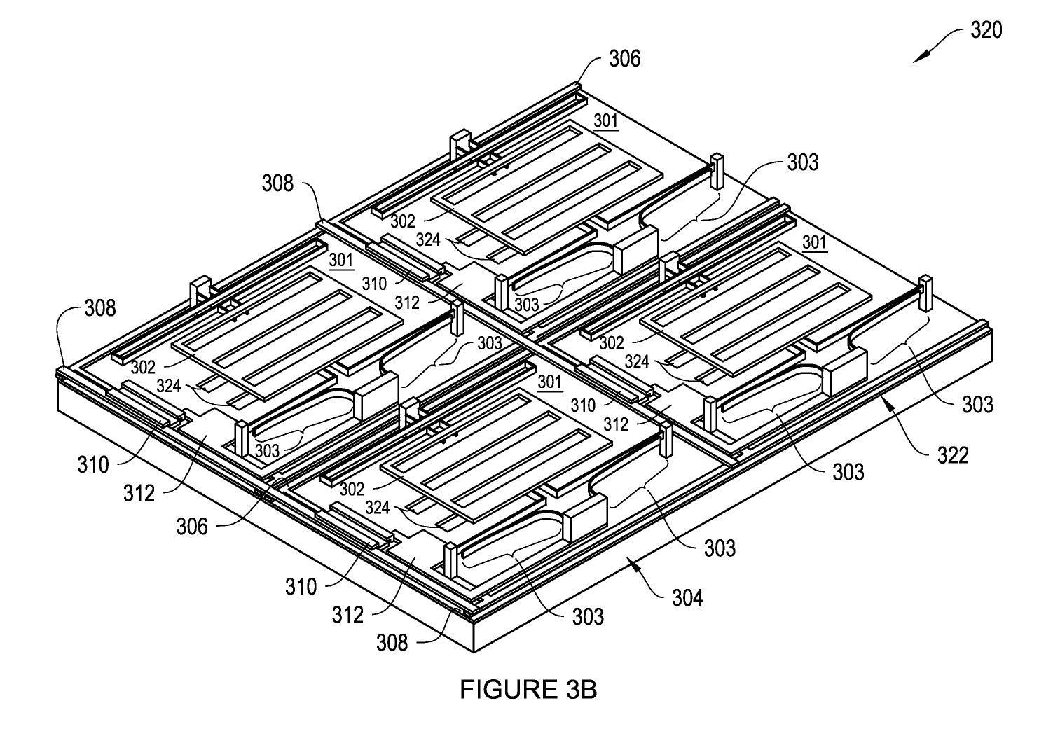

FIG. 3A shows a schematic diagram of an example control matrix 300. The control matrix 300 is suitable for controlling the light modulators incorporated into the MEMS-based display apparatus 100 of FIG. 1A. FIG. 3B shows a perspective view of an example array 320 of shutter-based light modulators connected to the control matrix 300 of FIG. 3A. The control matrix 300 may address an array of pixels 320 (the “array 320”). Each pixel 301 can include an elastic shutter assembly 302, such as the shutter assembly 200 of FIG. 2, controlled by an actuator 303. Each pixel also can include an aperture layer 322 that includes apertures 324.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source 309 (“V_{d} source”) to the pixels 301 in a corresponding column of pixels. In the control matrix 300, the V_{d} source 309 provides the majority of the energy to be used for actuation of the shutter assemblies 302. Thus, the data voltage source, V_{d} source 309, also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly actuates, opening the shutter in that shutter assembly 302. The voltage applied to the data interconnect 308 remains stored in the capacitor 312 of the pixel 301 even after the control matrix 300 ceases to apply V, to a row. Therefore, the voltage V, does not have to wait and hold on a row for times long enough for the shutter assembly 302 to actuate; such actuation can proceed after the write-enabling voltage has been removed from the row. The capacitors 312 also function as memory elements within the array 320, storing actuation instructions for the illumination of an image frame.

The pixels 301 as well as the control matrix 300 of the array 320 are formed on a substrate 304. The array 320 includes an aperture layer 322, disposed on the substrate 304, which includes a set of apertures 324 for respective pixels 301 in the array 320. The apertures 324 are aligned with the shutter assemblies 302 in each pixel. In some implementations, the substrate 304 is made of a transparent material, such as glass or plastic. In some other implementations, the substrate 304 is made of an opaque material, but in which holes are etched to form the apertures 324.

The shutter assembly 302 together with the actuator 303 can be made bi-stable. That is, the shutters can exist in at least two equilibrium positions (for example, open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 also can be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as the spring 207 in the shutter-based light modulator 200 depicted in FIG. 2, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division gray scale are possible where multiple MEMS light modulators in the pixel are provided, and where apertures 324, which are associated with each of the light modulators, have unequal areas.

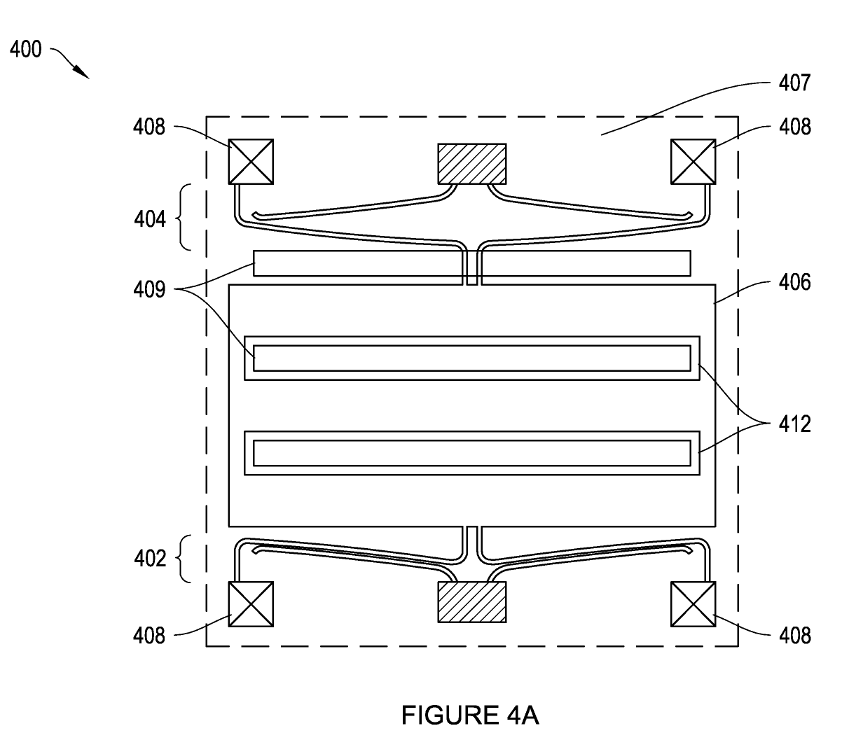

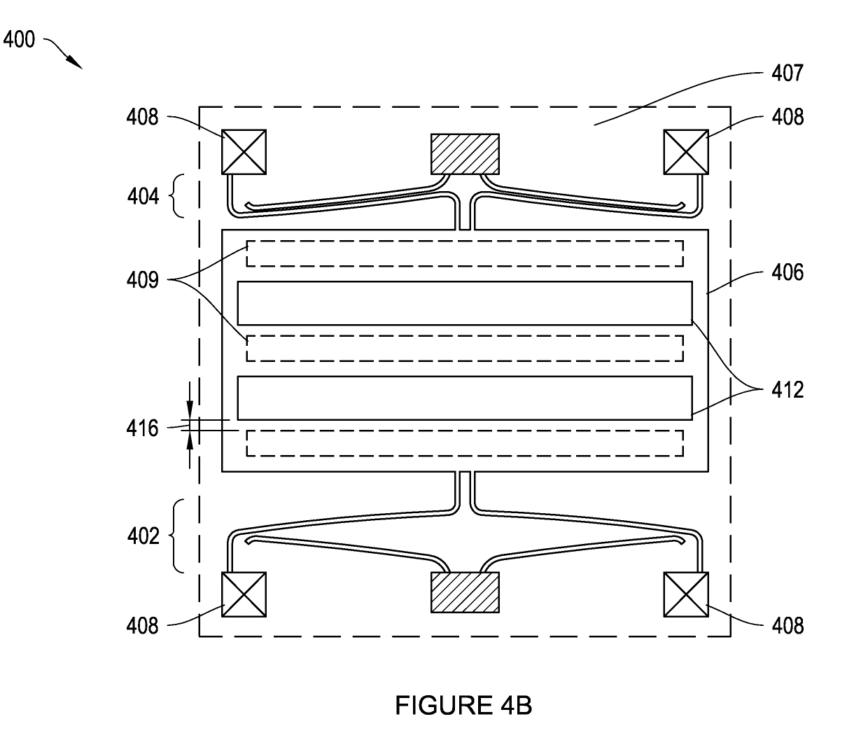

FIGS. 4A and 4B show views of an example dual actuator shutter assembly 400. The dual actuator shutter assembly 400, as depicted in FIG. 4A, is in an open state. FIG. 4B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with the shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 4B the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 4B shows a predefined overlap 416 between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

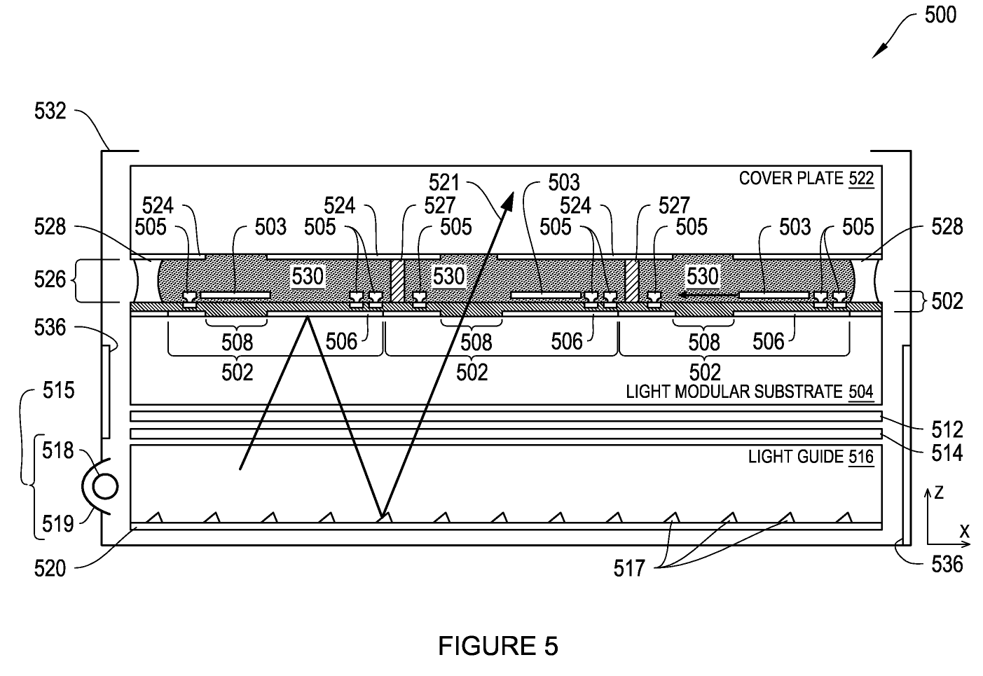

FIG. 5 shows a cross sectional view of an example display apparatus 500 incorporating shutter-based light modulators (shutter assemblies) 502. Each shutter assembly 502 incorporates a shutter 503 and an anchor 505. Not shown are the compliant beam actuators which, when connected between the anchors 505 and the shutters 503, help to suspend the shutters 503 a short distance above the surface. The shutter assemblies 502 are disposed on a transparent substrate 504, such a substrate made of plastic or glass. A rear-facing reflective layer, reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective aperture layer 506 can be a fine-grained metal film without inclusions formed in thin film fashion by a number of vapor deposition techniques including sputtering, evaporation, ion plating, laser ablation, or chemical vapor deposition (CVD). In some other implementations, the rear-facing reflective layer 506 can be formed from a mirror, such as a dielectric mirror. A dielectric mirror can be fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap is preferably less than the lateral overlap between the edge of shutters 503 and the edge of apertures 508 in the closed state, such as the overlap 416 depicted in FIG. 4B.

The display apparatus 500 includes an optional diffuser 512 and/or an optional brightness enhancing film 514 which separate the substrate 504 from a planar light guide 516. The light guide 516 includes a transparent, i.e., glass or plastic material. The light guide 516 is illuminated by one or more light sources 518, forming a backlight. The light sources 518 can be, for example, and without limitation, incandescent lamps, fluorescent lamps, lasers or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display apparatus 500 to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light redirectors 517 can be molded into the plastic body of light guide 516 with shapes that can be alternately triangular, trapezoidal, or curved in cross section. The density of the prisms 517 generally increases with distance from the lamp 518.

In some implementations, the aperture layer 506 can be made of a light absorbing material, and in alternate implementations the surfaces of shutter 503 can be coated with either a light absorbing or a light reflecting material. In some other implementations, the aperture layer 506 can be deposited directly on the surface of the light guide 516. In some implementations, the aperture layer 506 need not be disposed on the same substrate as the shutters 503 and anchors 505 (such as in the MEMS-down configuration described below).

In some implementations, the light sources 518 can include lamps of different colors, for instance, the colors red, green and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps, or red, green, blue and yellow lamps. In some other implementations, the light source 518 may include cyan, magenta, yellow and white lamps, red, green, blue and white lamps. In some other implementations, additional lamps may be included in the light source 518. For example, if using five colors, the light source 518 may include red, green, blue, cyan and yellow lamps. In some other implementations, the light source 518 may include white, orange, blue, purple and green lamps or white, blue, yellow, red and cyan lamps. If using six colors, the light source 518 may include red, green, blue, cyan, magenta and yellow lamps or white, cyan, magenta, yellow, orange and green lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a distance away, which in some implementations may be predetermined, from the shutter assemblies 502 forming a gap 526. The gap 526 is maintained by mechanical supports or spacers 527 and/or by an adhesive seal 528 attaching the cover plate 522 to the substrate 504.

The adhesive seal 528 seals in a fluid 530. The fluid 530 is engineered with viscosities preferably below about 10 centipoise and with relative dielectric constant preferably above about 2.0, and dielectric breakdown strengths above about 10⁴ V/cm. The fluid 530 also can serve as a lubricant. In some implementations, the fluid 530 is a hydrophobic liquid with a high surface wetting capability. In alternate implementations, the fluid 530 has a refractive index that is either greater than or less than that of the substrate 504.

Displays that incorporate mechanical light modulators can include hundreds, thousands, or in some cases, millions of moving elements. In some devices, every movement of an element provides an opportunity for static friction to disable one or more of the elements. This movement is facilitated by immersing all the parts in a fluid (also referred to as fluid 530) and sealing the fluid (for example, with an adhesive) within a fluid space or gap in a MEMS display cell. The fluid 530 is usually one with a low coefficient of friction, low viscosity, and minimal degradation effects over the long term. When the MEMS-based display assembly includes a liquid for the fluid 530, the liquid at least partially surrounds some of the moving parts of the MEMS-based light modulator. In some implementations, in order to reduce the actuation voltages, the liquid has a viscosity below 70 centipoise. In some other implementations, the liquid has a viscosity below 10 centipoise. Liquids with viscosities below 70 centipoise can include materials with low molecular weights: below 4000 grams/mole, or in some cases below 400 grams/mole. Fluids 530 that also may be suitable for such implementations include, without limitation, de-ionized water, methanol, ethanol and other alcohols, paraffins, olefins, ethers, silicone oils, fluorinated silicone oils, or other natural or synthetic solvents or lubricants. Useful fluids can be polydimethylsiloxanes (PDMS), such as hexamethyldisiloxane and octamethyltrisiloxane, or alkyl methyl siloxanes such as hexylpentamethyldisiloxane. Useful fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. Other fluids considered for these display assemblies include butyl acetate and dimethylformamide. Still other useful fluids for these displays include hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

A sheet metal or molded plastic assembly bracket 532 holds the cover plate 522, the substrate 504, the backlight and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of the light guide 516 back into the light guide 516. Not depicted in FIG. 5 are electrical interconnects which provide control signals as well as power to the shutter assemblies 502 and the lamps 518.

The display apparatus 500 is referred to as the MEMS-up configuration, thus, the MEMS based light modulators are formed on a front surface of the substrate 504, i.e., the surface that faces toward the viewer. The shutter assemblies 502 are built directly on top of the reflective aperture layer 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in the display apparatus 500 and is oriented such that the MEMS-based light modulators are positioned on the rear surface of the top substrate, i.e., the surface that faces away from the viewer and toward the light guide 516. The MEMS-based light modulators are thereby positioned directly opposite to and across a gap from the reflective aperture layer 506. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures is preferably less than 10 microns, or a distance that is less than the overlap between shutters and apertures, such as overlap 416.

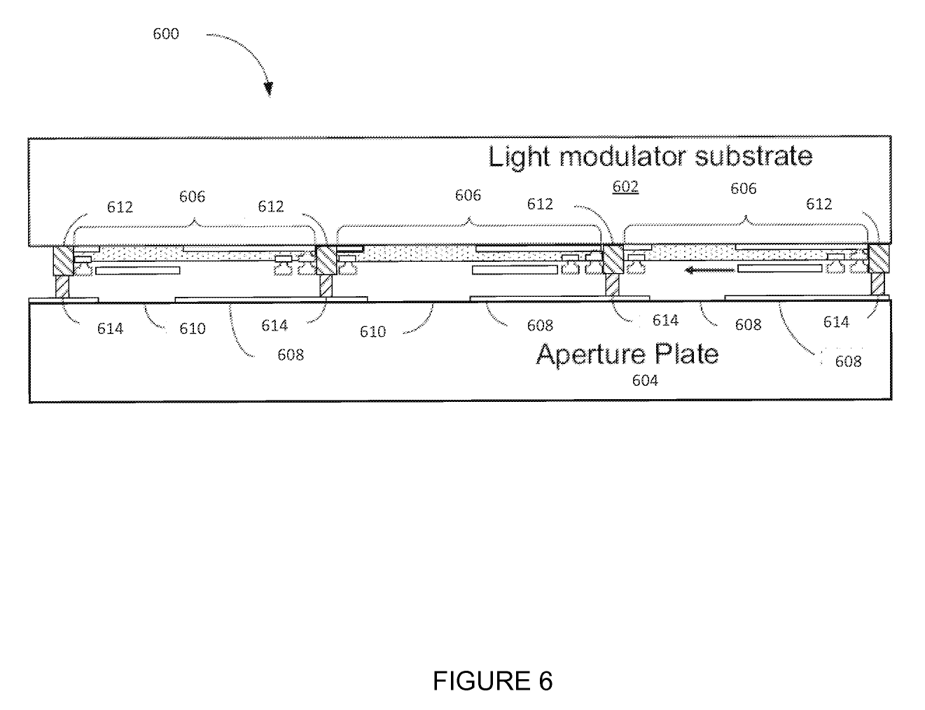

FIG. 6 shows a cross sectional view of an example light modulator substrate and an example aperture plate for use in a MEMS-down configuration of a display. The display assembly 600 includes a modulator substrate 602 and an aperture plate 604. The display assembly 600 also includes a set of shutter assemblies 606 and a reflective aperture layer 608. The reflective aperture layer 608 includes apertures 610. A gap or separation between the modulator substrates 602 and the aperture plate 604, which in some implementations may be predetermined, is maintained by the opposing set of spacers 612 and 614. The spacers 612 are formed on or as part of the modulator substrate 602. The spacers 614 are formed on or as part of the aperture plate 604. During assembly, the two substrates 602 and 604 are aligned so that spacers 612 on the modulator substrate 602 make contact with their respective spacers 614.

The separation or distance of this illustrative example is 8 microns. To establish this separation, the spacers 612 are 2 microns tall and the spacers 614 are 6 microns tall. Alternately, both spacers 612 and 614 can be 4 microns tall, or the spacers 612 can be 6 microns tall while the spacers 614 are 2 microns tall. In fact, any combination of spacer heights can be employed as long as their total height establishes the desired separation H12.

Providing spacers on both of the substrates 602 and 604, which are then aligned or mated during assembly, has advantages with respect to materials and processing costs. The provision of a very tall, such as larger than 8 micron spacers, can be costly as it can require relatively long times for the cure, exposure, and development of a photo-imageable polymer. The use of mating spacers as in display assembly 600 allows for the use of thinner coatings of the polymer on each of the substrates.

In another implementation, the spacers 612 which are formed on the modulator substrate 602 can be formed from the same materials and patterning blocks that were used to form the shutter assemblies 606. For instance, the anchors employed for shutter assemblies 606 also can perform a function similar to spacer 612. In this implementation, a separate application of a polymer material to form a spacer would not be required and a separate exposure mask for the spacers would not be required.

In the shutter assemblies described above, the actuators are primarily designed for moving a shutter between two states: fully open and fully closed. To switch between these states, the shutters are moved by their respective actuators along a first axis. The actuators are designed to be relatively stiff in all directions other than along the first axis to constrain the motion of the shutter, to the extent possible, to likewise be along the first axis. Providing an additional axis of motion for a shutter assembly can enable the shutter assembly to achieve additional states between fully open and fully closed.

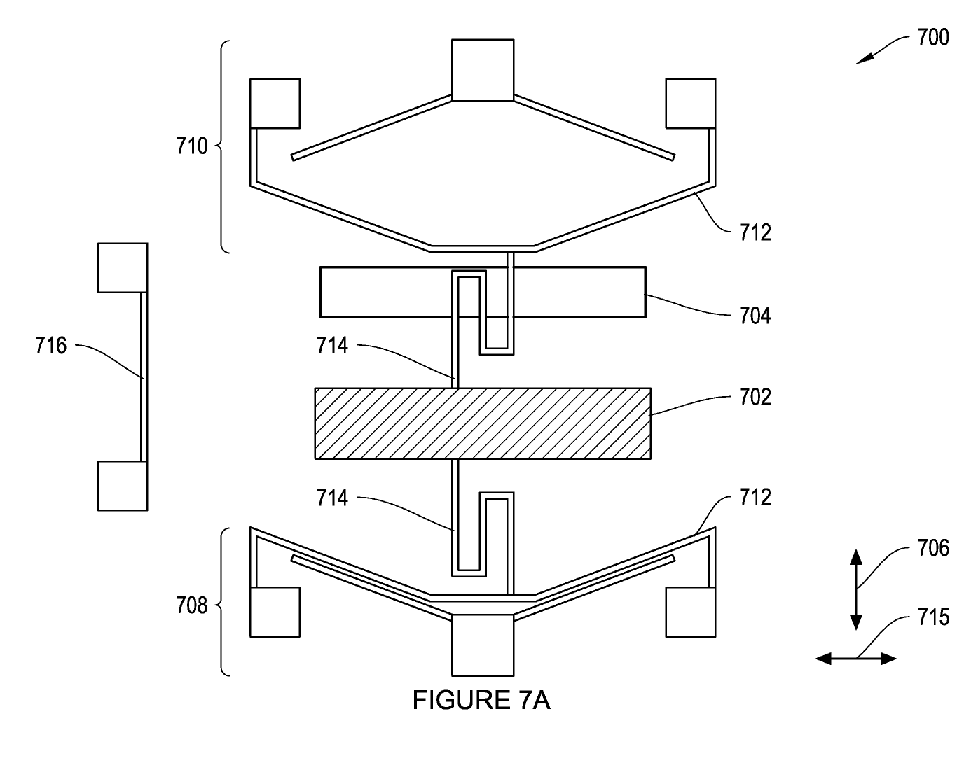

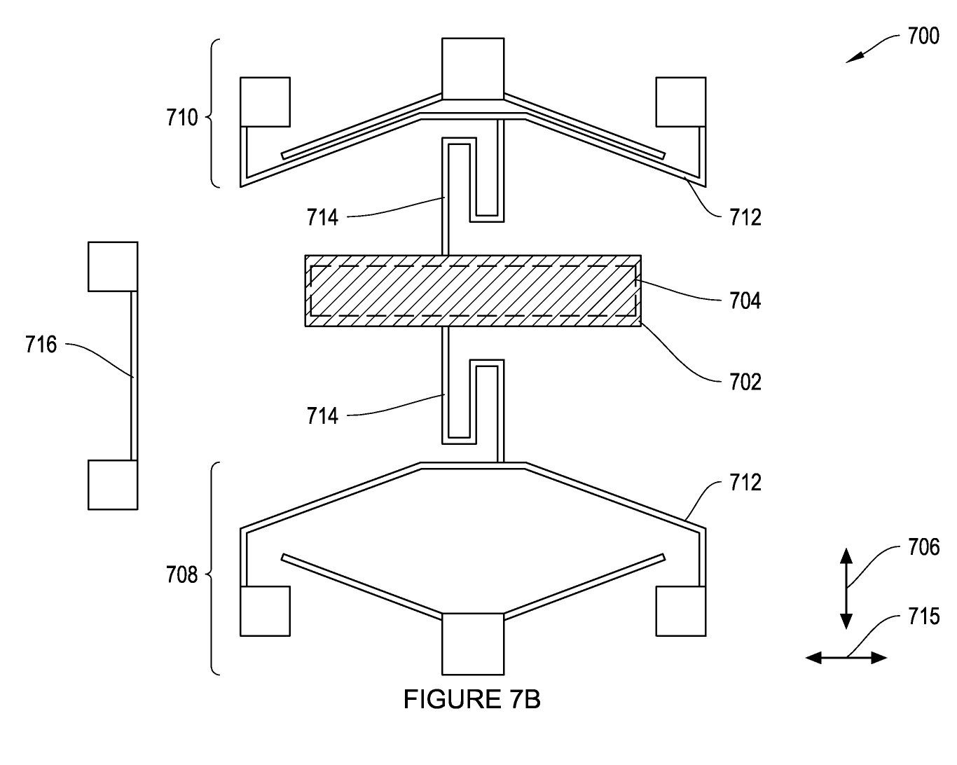

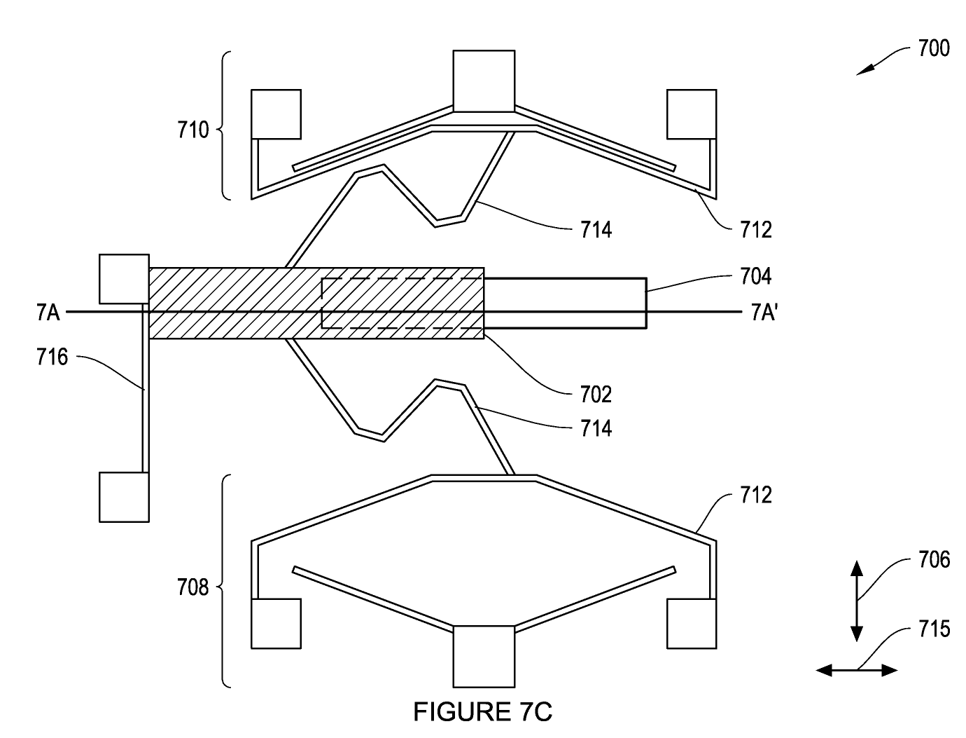

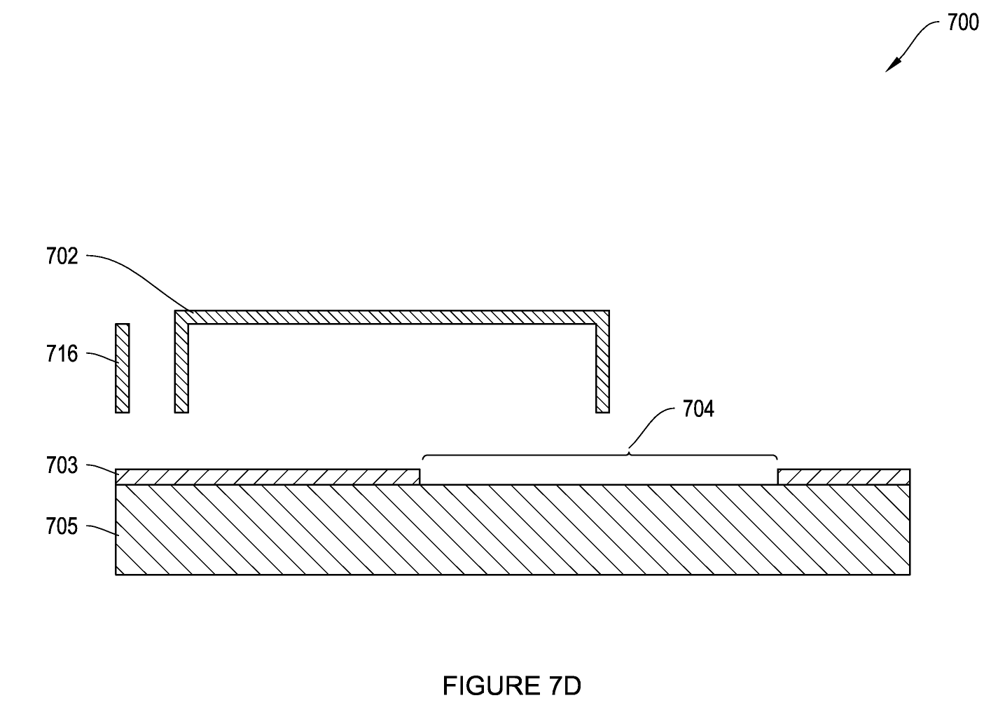

FIGS. 7A-7C show plan views of an example multi-state shutter assembly 700. FIG. 7D shows a cross-sectional view of the multi-state shutter assembly 700 shown in FIGS. 7A-7C. The shutter assembly 700 is capable of reliably achieving three distinct states. FIG. 7A shows the shutter assembly 700 in a light transmissive state. FIG. 7B shows the shutter assembly 700 in a light blocking state. FIG. 7C shows the shutter assembly 700 in a partially light transmissive state.

Referring to FIGS. 7A-7D, the shutter assembly 700 includes a shutter 702 suspended over a substrate 705. An aperture 704 is defined within a light blocking layer 703 (shown in FIG. 7D) deposited on the substrate 705. The shutter 702 is driven along a first axis 706 by two electrostatic actuators, a shutter open actuator 708 and a shutter close actuator 710. The shutter 702 is supported by a pair of load beams 712 that form a portion of the respective shutter open and shutter close actuators 708 and 710. The load beams 712 couple to the shutter 702 via folded beams 714 that allow for movement of the shutter 702 along a second axis 715, perpendicular to the first axis 706. The folded beams 714 shown in FIGS. 7A-7D are serpentine in shape in that they form a shape similar to the letter “S.” In some other implementations, the folded beams 714 can be replaced with any other curved or folded configuration that can be expanded in response to the application of an appropriate force, thereby elongating the beam. In addition, the shutter assembly 700 includes a side electrode 716.

When a potential is applied across the shutter 702 and the side electrode 716, the shutter 702 is drawn towards the side electrode 716 along the second axis 715. That is, the shutter 702 and the side electrode 716 form opposing electrodes of a third electrostatic actuator. In some implementations, the side electrode 716 is about as long as the length of the shutter 702 along the first axis 706, and is centered at a position that corresponds to the center of the shutter 702 in its closed position. In some implementations, the side electrode 716 is longer than the length of the shutter 702 along the first axis 706.

In FIG. 7A, the shutter open actuator 708 is energized, pulling the shutter 702 towards the shutter open actuator 708. This results in the shutter assembly 700 achieving a light transmissive state, with the shutter 702 spaced away from the aperture 704.

In FIG. 7B, the shutter close actuator 710 is energized, pulling the shutter 702 towards the shutter close actuator 710. This results in the shutter assembly 700 entering a light blocking state in which the shutter 702 completely covers the aperture 704.

In FIG. 7C, both the shutter close actuator 710 and the side electrode 716 are energized, drawing the shutter 702 towards the side electrode 716, while still partially covering the aperture 704. In the example implementation, the side electrode 716 is spaced at a distance such that when it is actuated, the shutter 702 moves sufficiently far that about 50% of the aperture 704 is uncovered. This results in the shutter assembly 700 entering a first partially transmissive state in which about 50% of the total light transmitted through the aperture 704 is allowed to leave a display towards a viewer.

As shown in FIG. 7C, the folded beams 714 of the shutter open and shutter close actuators 708 and 710 are elongated, partially opening the folded shape, to allow the shutter 702 to move along the second axis 715. This opening stores a stress on the folded beams 714. When the potential across the shutter 702 and the side electrode 716 is removed, the folded beams 714 contract back to their original shape to move the shutter back along the second axis 715 to its initial position on the second axis.

In some other implementations, the side electrode 716 is spaced at a different relative distance from the shutter 702. For example, in some implementations, the side electrode 716 is spaced at a distance, such that upon its actuation, the shutter is drawn sufficiently far to the side that it covers about 12.5%, about 25%, about 33%, about 37.5%, about 62.5%, about 66%, about 75% or about 87.5% of the aperture 704, allowing a corresponding amount of light i.e., about 87.5%, about 75%, about 67%, about 62.5%, about 37.5%, about 33%, about 25%, or about 12.5%, to pass through the aperture 704. In general, the distance between the side electrode 716 and the shutter 702 can be any arbitrary distance corresponding to any degree of aperture 704 coverage and fractional light throughput so long as the imaging algorithm used with the shutter 702 accounts for the appropriate distance.

The specific distance of the side electrode 716 from the shutter 702 can be selected based on the imaging algorithm intended to be used with the light modulator, the voltage and power specifications of the display, and the desired resolution of the display. Greater separation distances generally require higher voltages for actuation, result in greater power consumption, and allocate more space for each pixel resulting in a lower resolution.

Referring now to FIG. 7D, the cross-sectional view shown therein is taken along the line 7A-7A′ depicted in FIG. 7C. As shown in FIG. 7D, in some implementations, the shutter 702 includes a sidewall 720 that surrounds the perimeter of the shutter 702. In some other implementations the sidewall does not fully surround the perimeter of the shutter 702. Instead, the sidewall 720 separately extends off or one or more of the exterior edges of the shutter 702, for example, the edge of the shutter 702 adjacent to the side electrode 716. The sidewall 720 provides additional surface area that is both parallel and proximate to the primary surface of the side electrode 716. This surface area provides for improved interaction with the side electrode 716, reducing the voltage necessary to actuate the third actuator.

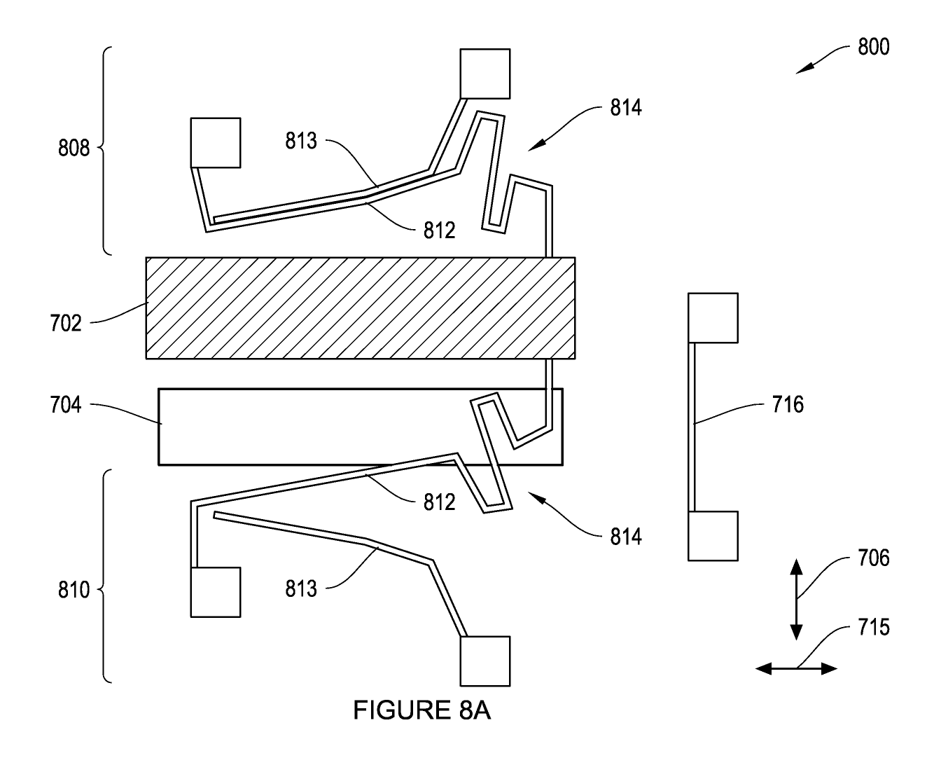

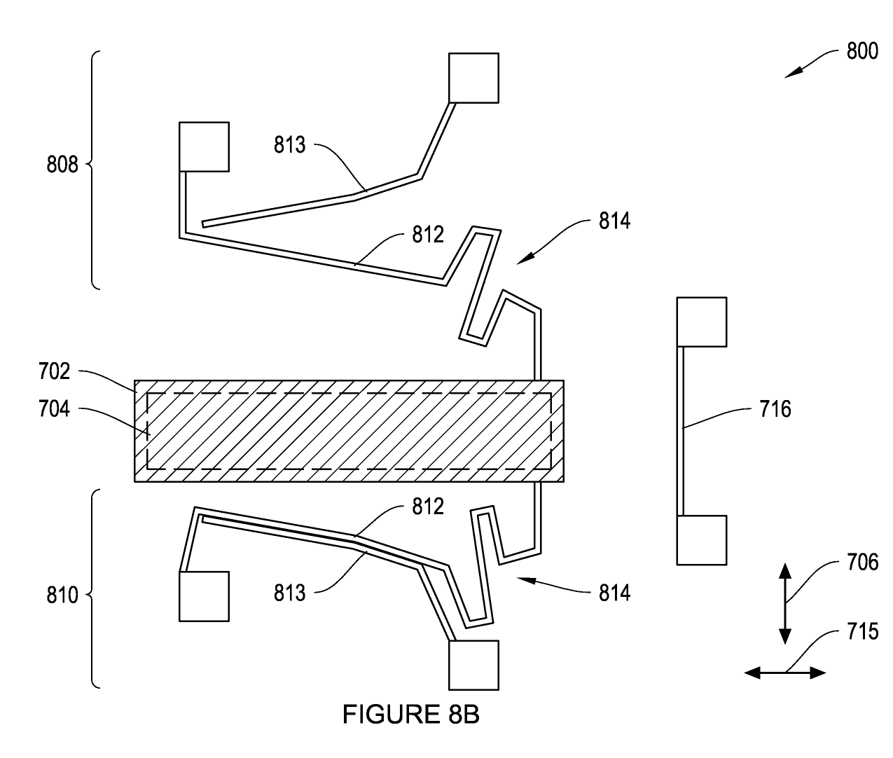

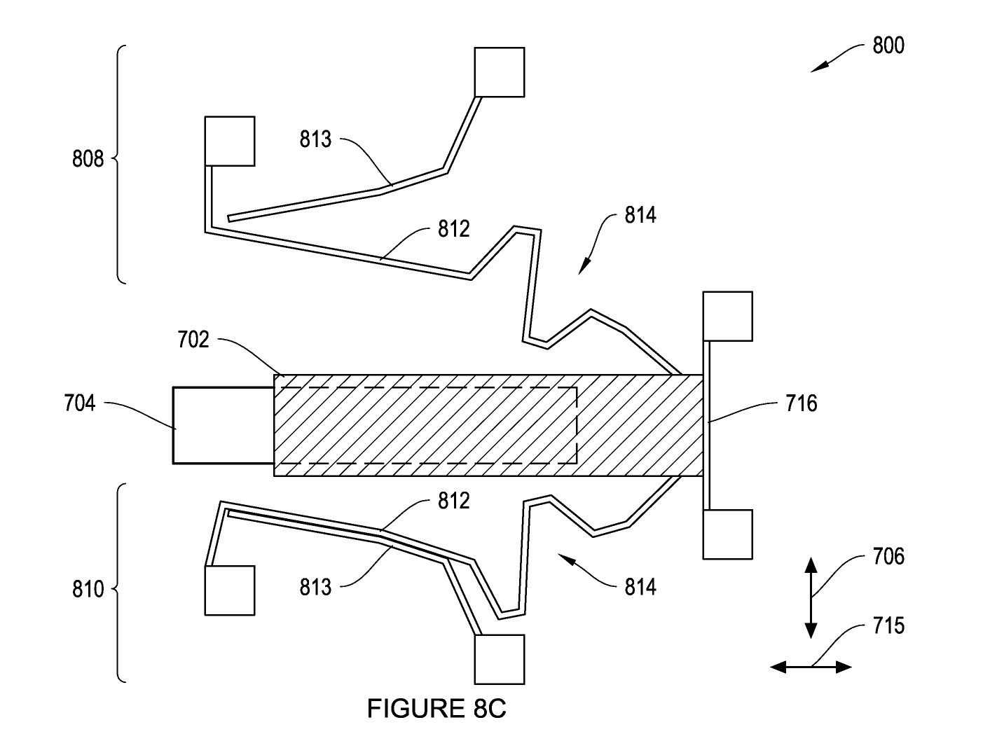

FIGS. 8A-8C show plan views of another example multi-state shutter assembly 800. The shutter assembly 800 is similar to the shutter assembly 700 shown in FIGS. 7A-7D, other than with respect to the form of its shutter open and shutter close actuators 808 and 810. As such, similar components are labeled with the same reference numerals used in FIGS. 7A-7D. FIG. 8A shows the shutter assembly 800 in a light transmissive state. FIG. 8B shows the shutter assembly 800 in a light blocking state. FIG. 8C shows the shutter assembly 800 in a partially transmissive state, unblocking about 25% of an aperture 704.

The shutter assembly 800, instead of having the shutter open and shutter close actuators 708 and 710 couple to the shutter 702 at about the middle of the shutter 702, the shutter open and shutter close actuators 808 and 810 couple to one side of the shutter 702. In the implementation shown in FIGS. 8A-8C, the shutter open and shutter close actuators 808 and 810 couple to the shutter 702 on the side of the shutter 702 closest to the side electrode 716. In some other implementations, the shutter open and shutter close actuators 808 and 810 couple to the side of the shutter 702 furthest from the side electrode 716.

The shutter open and shutter close actuators 808 and 810 also differ from the shutter open and shutter close actuators 708 and 710 in the number and arrangement of the electrode beams that form the respective actuators. Each of the shutter open and shutter close actuators 808 and 810 shown in FIGS. 8A-8C include a single load beam 812 and a single drive beam 813. The shutter open and shutter close actuators 808 and 810 move the shutter 702 along the first axis 706. The load beam 812 includes a folded portion 814 to allow the shutter to be moved along the second axis 715. In contrast, the shutter assembly 700 included separate folded beams 714 that couple the load beams 712 to the shutter 702.

Referring back to FIGS. 8A-8C, when a potential is applied across the shutter 702 and the side electrode 716, the shutter 702 is moved along the second axis 715, elongating the folded portion 814 of the load beams 812, opening the folded shape of the load beam 812, and storing a potential energy in the load beams 812. Upon removal of the potential, this potential energy converts to kinetic energy returning the shutter 702 into its original position along the second axis 715.

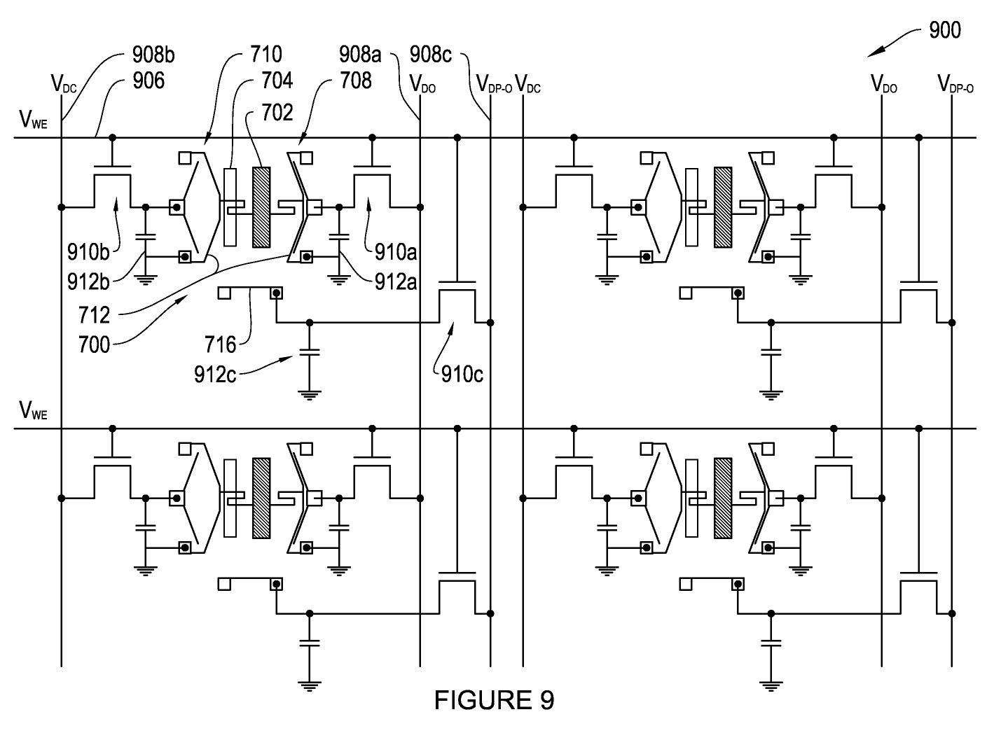

FIG. 9 shows a schematic diagram of an example control matrix 900. The control matrix 900 is suitable for controlling multi-state shutter assemblies, including either of the shutter assemblies 700 or 800 shown in FIGS. 7A-7D and 8A-8C as well as other shutter assemblies including a single side electrode in addition to a shutter open and a shutter close actuator. However, merely to simplify the explanation, aspects of the control matrix 900 are described herein in relation to the shutter assembly 700.

The control matrix 900 is similar to the control matrix 300 shown in FIGS. 3A and 3B, though it includes additional circuitry to control the two additional actuators included in the multi-state shutter assembly 700.

Accordingly, for each row of the multi-state shutter assemblies 700, the control matrix 900 includes a scan-line interconnect 906. For each column of shutter assemblies 700, the control matrix 900 includes three data interconnects, a shutter-open data interconnect 908a, a shutter-close data interconnect 908b, and a shutter partial-open data interconnect 908c. The data interconnects 908a-908c carry the voltages needed to actuate the multi-state shutter assemblies 700, and thus serve the dual roles of providing both data to a shutter assembly (by being either on or off), as well as an actuation voltage. Thus the data interconnects 908a-908c can be considered both data interconnects and actuation interconnects.

Each data interconnect 908a-908c includes a corresponding transistor 910a-910c and capacitor 912a-912c. The gates of all of the transistors 910a-910c along a row of the multi-state shutter assemblies 700 are coupled to the scan-line interconnect 906 that correspond to that row. For a given shutter assembly 700 in the row, the drain of the transistor 910a is coupled to the shutter-open data interconnect 908a, the drain of the transistor 910b is coupled to the shutter-close data interconnect 908b, and the drain of the transistor 910c is coupled to the shutter-partial-open data interconnect 908c. The source of the transistor 910a is coupled in parallel to the capacitor 912a and the drive beam of the shutter open actuator 708. The source of the transistor 910b is coupled in parallel to the capacitor 912b and to the drive beam of the shutter close actuator 710. The source of the transistor 910c is coupled in parallel to the capacitor 912c and to the side electrode 716. The load electrodes 712 of the shutter open and shutter close actuators 708 and 710 are coupled to ground.

In operation, the control matrix 900 simultaneously addresses and actuates each row of shutter assemblies 700, one row at a time. Specifically, at the beginning of a row addressing and actuation cycle, a write-enabling voltage V_{WE} is applied to a corresponding scan-line interconnect 906, turning on the transistors 910a-910c of each shutter assembly in the row. Then, actuation voltages are selectively applied to the data interconnects 908a-908c for each column of the multi-state shutter assemblies 700 depending on image data loaded into the control matrix, thereby actuating the actuators that receive the actuation voltage. For the shutter open actuators 708 and the shutter close actuators 710, the actuation voltage (V_{DO} or V_{DC}) may range from about 15V-40V, depending on the specific configuration of the shutter assembly 700. Depending on the separation distance between the side electrode 716 and the shutter 702, among other factors, the actuation voltage (V_{DP-O}) applied to the shutter partial-open data interconnect 908c to actuate the side actuator may range from about 20V for small separation distances to about 60V for larger separation distances.

After the shutters 702 enter their desired states, the control matrix 900 removes the voltage from the scan-line interconnect 906, and begins the cycle again for the next row of the multi-state shutter assemblies 700.

In some other implementations, control matrices that control multi-state shutter assemblies, such as the multi-state shutter assemblies 700 and 800 depicted in FIGS. 7A-7D and 8A-8C, include separate data interconnects and actuation interconnects for each actuator in a column of shutter assemblies. In some other implementations, a control matrix can include a separate data interconnect for each set of actuators in a column, but it may share actuation interconnects between two or more sets of the actuators in the column. For example, such a control matrix may include a shutter-open data interconnect, a shutter-close data interconnect and a shutter-partial-open data interconnect for each column of shutter assemblies. The shutter open and shutter close actuators in each column may be coupled to a shared actuation interconnect, whereas the side electrodes may be coupled to a separate actuation interconnect.

In some other implementations, a control matrix for a multi-state shutter assembly can incorporate one or more global common interconnects, such as a global actuation or a global pre-charge interconnect. A global common interconnect couples to shutter assemblies in multiple rows and multiple columns of a control matrix.

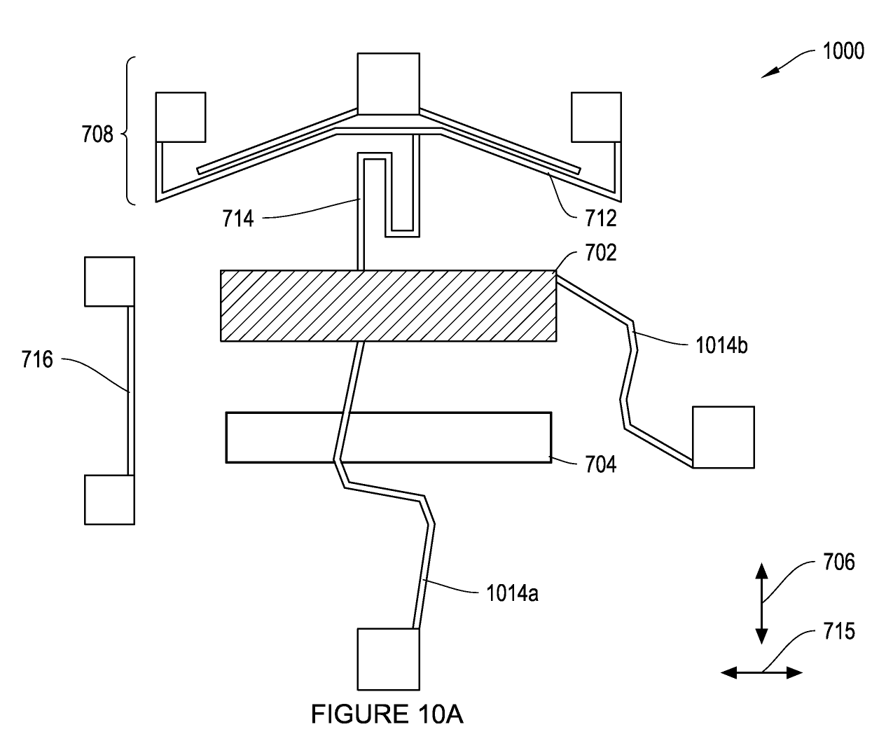

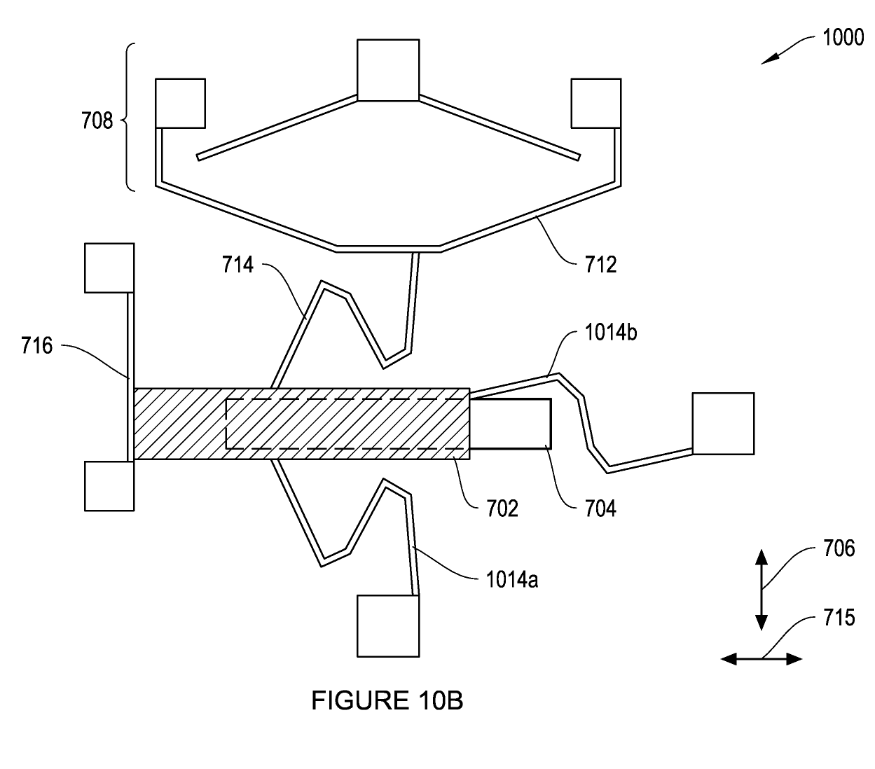

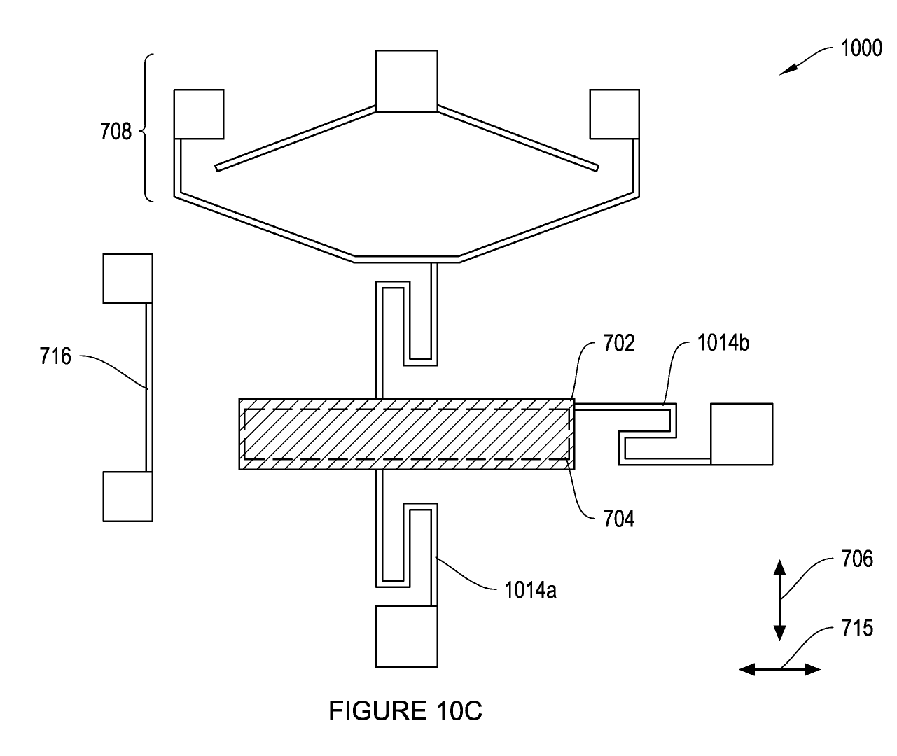

FIGS. 10A-10C show plan views of another example multi-state shutter assembly 1000. FIG. 10A shows the shutter assembly 1000 in the fully open state. FIG. 10B shows the shutter assembly 1000 in the partially open state. FIG. 10C shows the shutter assembly 1000 in a closed state.

The shutter assembly 1000 is similar to the shutter assembly 700 shown in FIGS. 7A-7D, and common components there between share common reference numerals. In contrast to the shutter assembly 700 shown in FIGS. 7A-7D, the shutter assembly 1000 includes only one actuator, a shutter open actuator 708, for moving the shutter 702 along the first axis 706. The shutter close actuator 710 shown in FIGS. 7A-7D is instead replaced by a folded return spring 1014. A second folded return spring 1014b also is added opposite the side electrode 716.

The folded return spring 1014a serves to apply a restoring force to the shutter 702, opposing the force applied by the shutter open actuator 702, while still allowing the shutter to move along the second axis 715. Thus, if the shutter 702 is in an open position, when the shutter open actuator 708 is deactivated, the folded return spring 1014a can reliably move the shutter back into a closed position, without having to energize an opposing actuator.

The second folded return spring 1014b serves to apply a restoring force to the shutter 702, opposing the force applied by the side electrode 716, while still allowing the shutter to move along the first axis 706. Thus, if the shutter is in a partially open state, when the side electrode 716 is deactivated, the folded return spring 1014a can reliably move the shutter 702 back into a fully closed position.

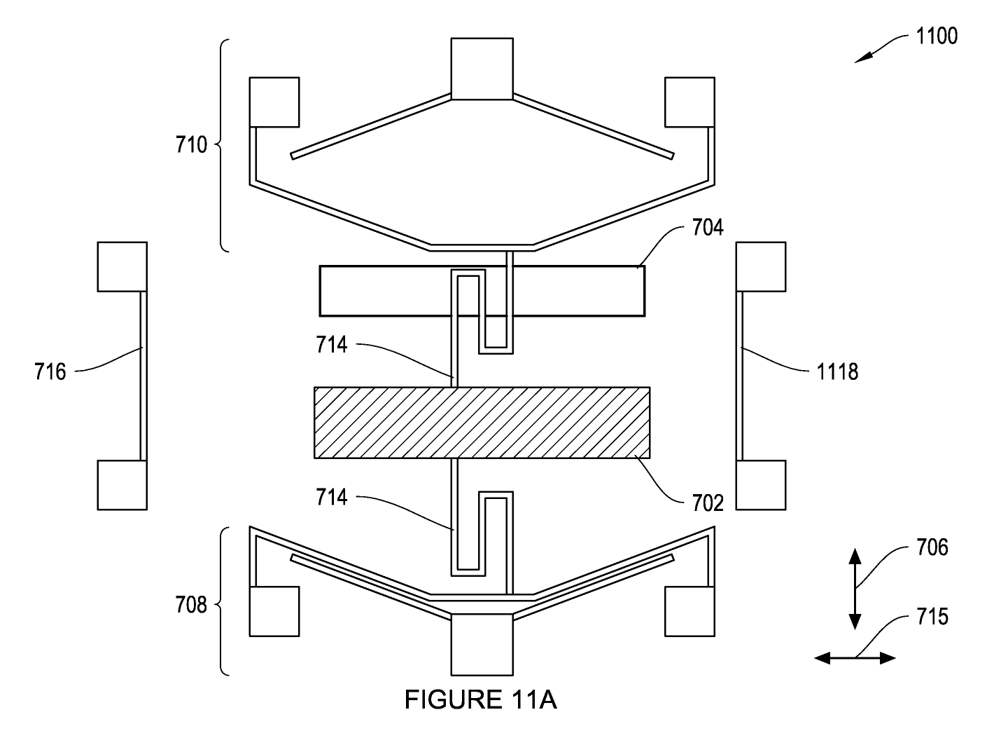

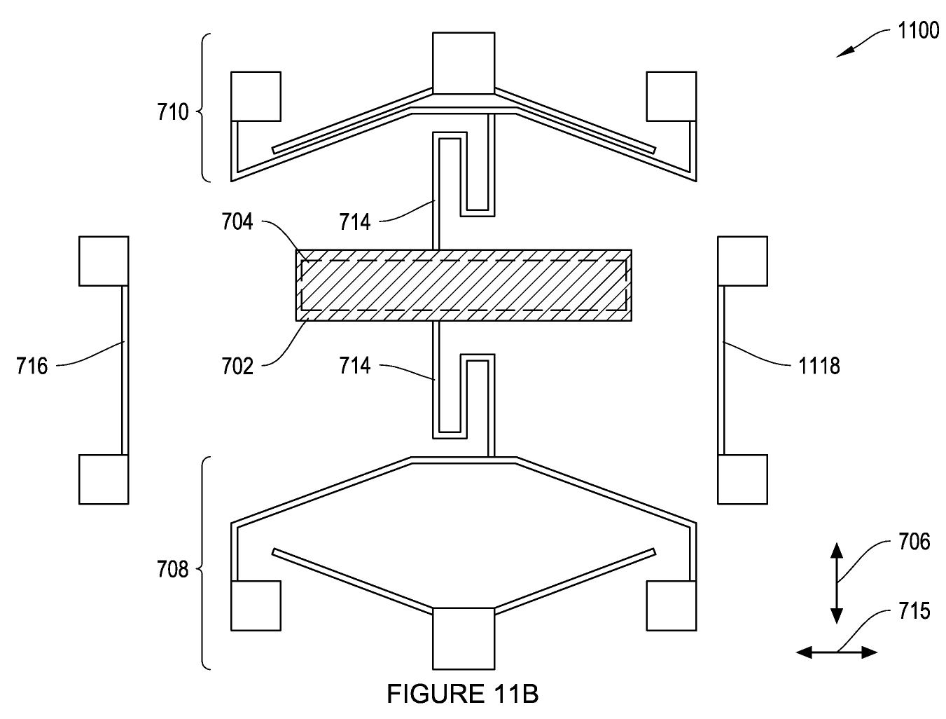

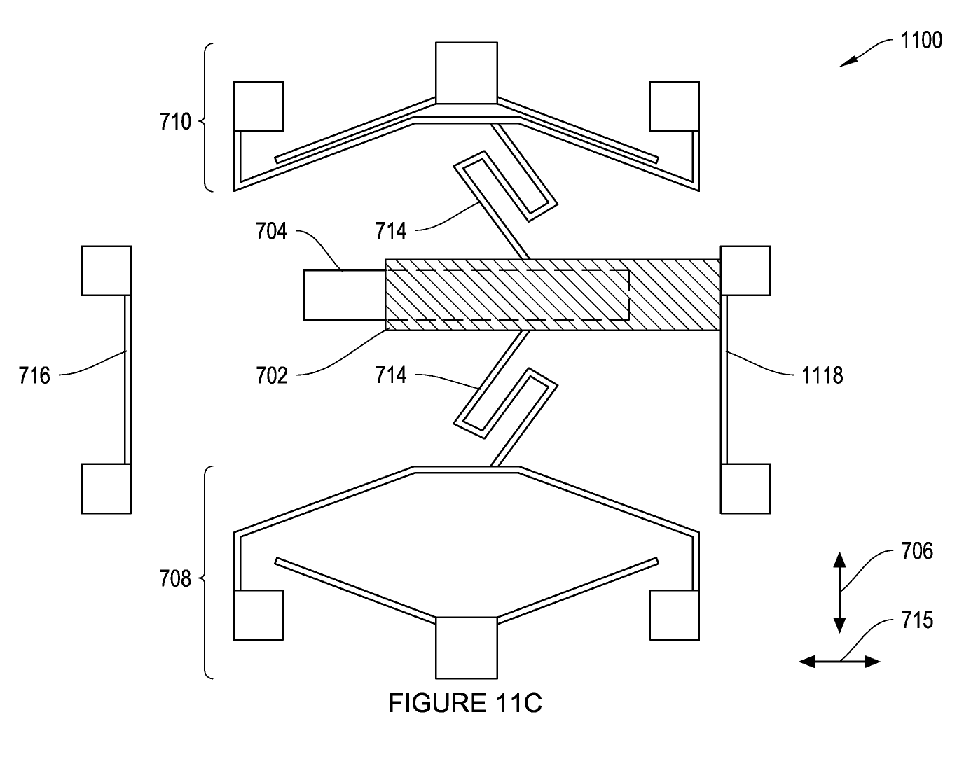

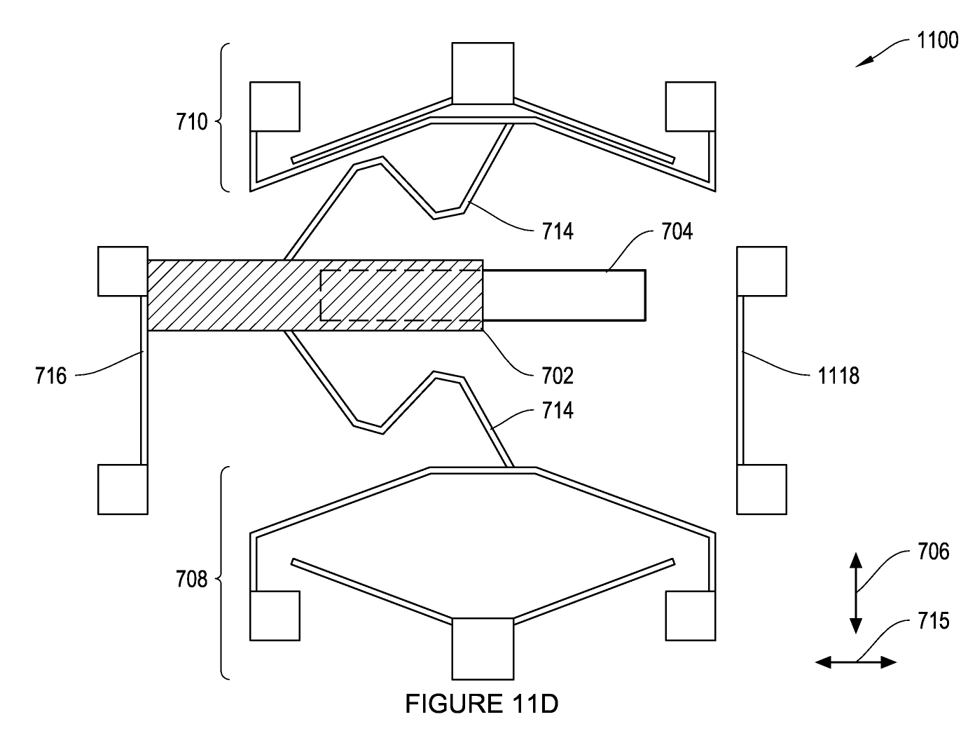

FIGS. 11A-11D shown plan views of another example multi-state shutter assembly 1100. The shutter assembly 1100 shown in FIGS. 11A-11D is similar to the multi-state shutter assembly 700 shown in FIG. 7, except that the shutter assembly 1100 is configured to be moved between four distinct states, instead of just three. Specifically, FIG. 11A shows the shutter assembly 1100 in an open position. FIG. 11B shows the shutter assembly 1100 in a closed position. FIG. 11C shows the shutter assembly 1100 in an about 25% open position. FIG. 11D shows the shutter assembly in an about 50% open position.

The shutter assembly 1100 can be moved into a fourth state as a result of the inclusion of a second side electrode 1118. The second side electrode 1118 is positioned on the opposite side of the shutter 702 from the side electrode 716. In some implementations, the distance between the second side electrode 1118 and the shutter 702 is different than the distance separating the shutter and the side electrode 716.

For example, in some implementations, the side electrode 716 is spaced at a distance such that the application of a voltage to the side electrode 716 (when the shutter would otherwise be in a closed position) moves the shutter 702 into a position in which about 50% of the aperture 704 is uncovered. In some such implementations, the separation distance between the second side electrode 1118 and the shutter 702 is half that distance. Accordingly, when actuated, the second side electrode 1118 pulls the shutter into a position in which about 25% of the aperture 704 is uncovered. Thus, at any given time, the shutter assembly 1100 can be in a fully closed state, a quarter-open state, a half-open state, or a fully open state. In some other implementations, the side electrode 716 and second side electrode 1118 are positioned at distances that move the shutter into an about one-third open state and an about two-thirds open state, respectively. Such shutter assemblies 1100 can be moved between a fully closed state, a one-third open state, a two-thirds open state, and a fully open state. In some other implementations, the side electrode 716 and the second side electrode 1118 are positioned at other distances from the shutter to allow a variety of different corresponding transmissivity levels.

As shown in FIGS. 7A-7C, 8A-8C, 10A-10C and 11A-11C, the side electrode 716 takes the form of a substantially straight, planar beam having a primary face that is normal to the substrate over which it is formed. In some other implementations, the side electrode 716 includes one or more features to reduce the likelihood of stiction between the shutter 702 and the side electrode 716. For example, in some implementations, the side electrode may have a slight curve or have a shallow serpentine shape to limit the area of the primary face of the shutter that could come into contact with the sidewall 720 of the shutter 702. In some other implementations, the side electrode 716 may include one or more narrow anti-stiction ridges or bumps that protrude out from the primary face of the side electrode 716 towards the shutter 702, having a length that is normal to the substrate. In such implementations, the sidewall 720 of the shutter would only contact the ends of the ridges or bumps, instead of the primary face of the side electrode 716.

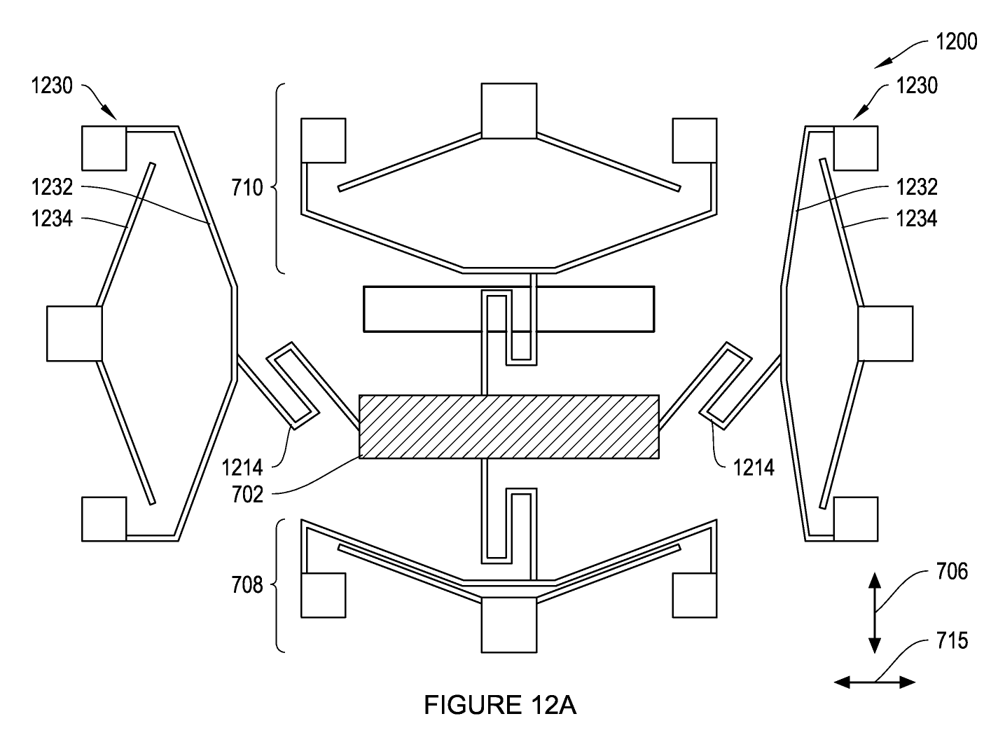

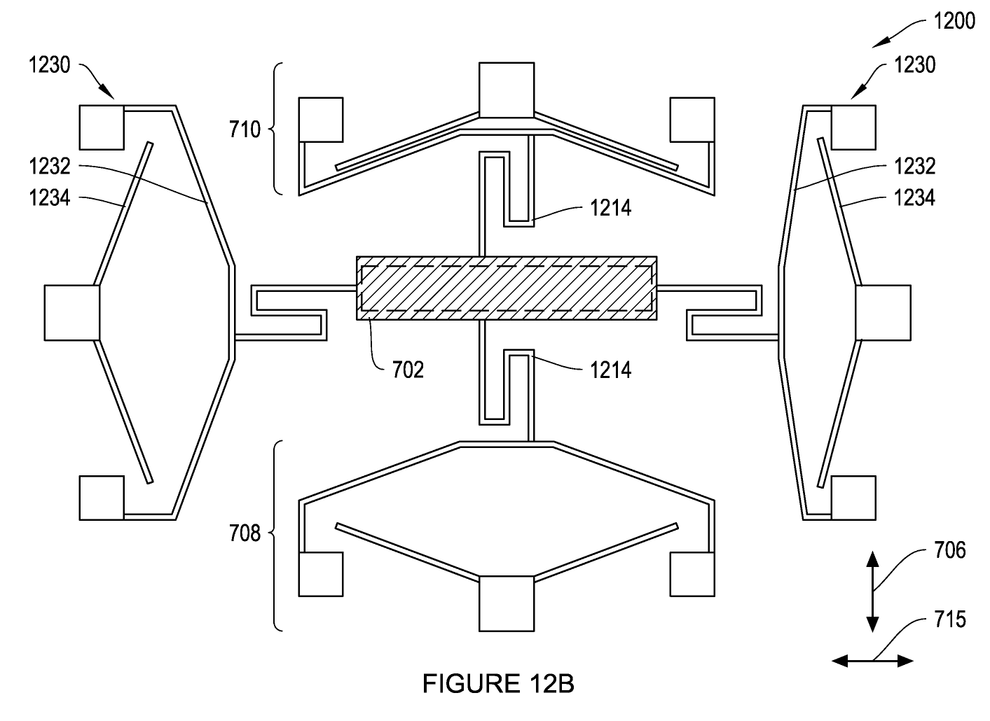

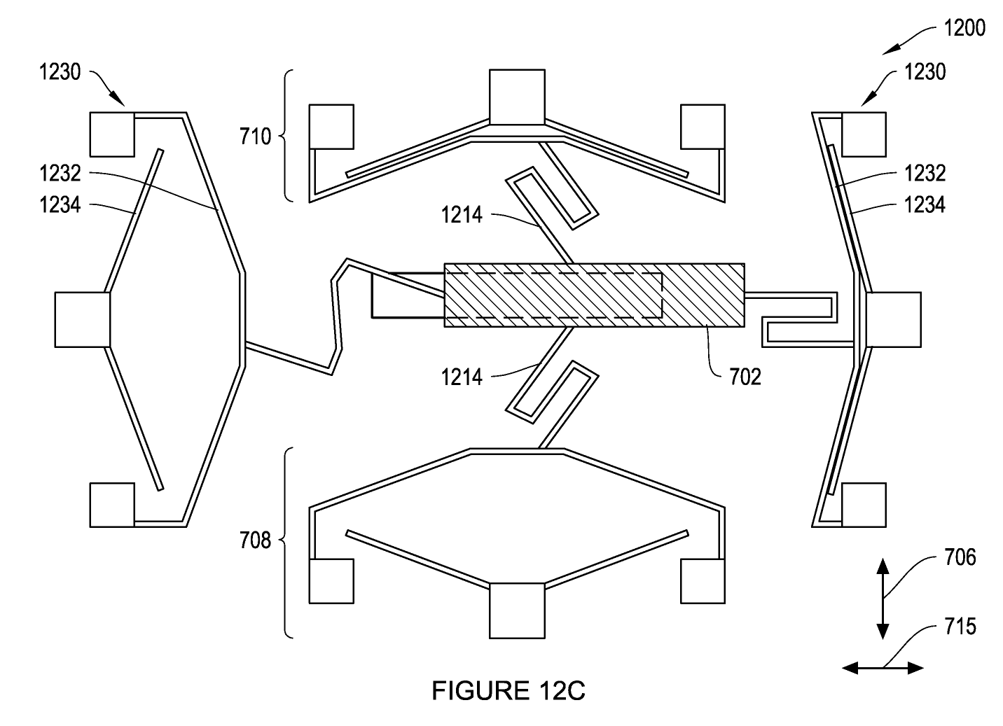

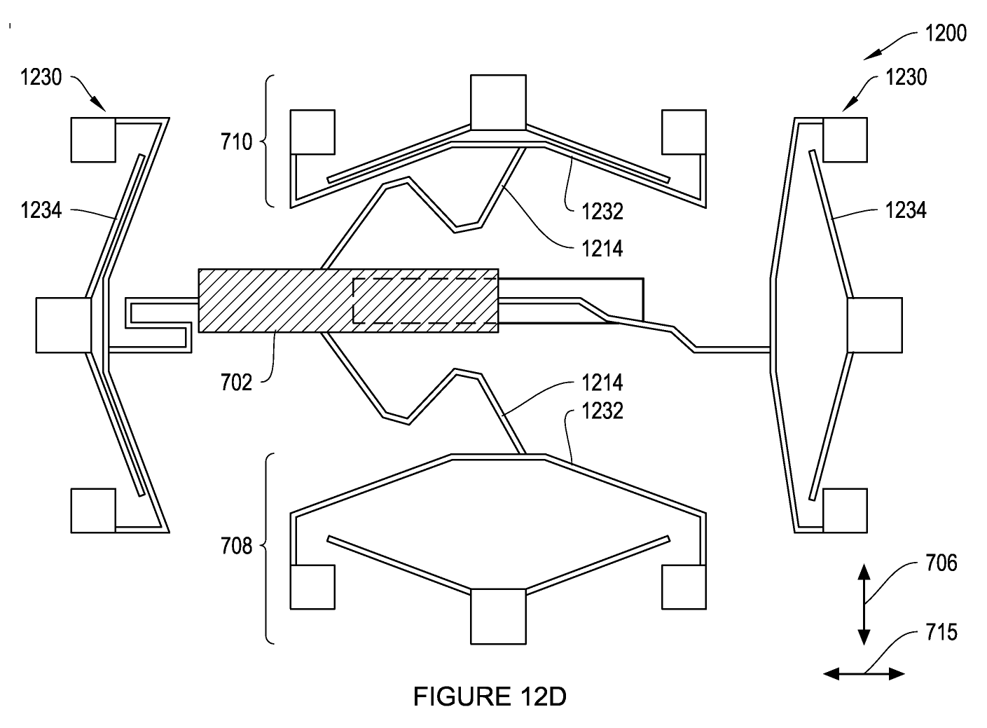

FIGS. 12A-12D show plan views of another example multi-state shutter assembly 1200. The shutter assembly 1200 can be moved into four distinct states, an open state (shown in FIG. 12A), a closed state (shown in FIG. 12B), and two different partially open states (shown in FIGS. 12C and 12D, respectively).

The shutter assembly 1200 is similar to the shutter assembly 1100 shown in FIGS. 11A-11C. The shutter assembly 1200, however, includes different actuation mechanisms for moving the shutter along the second axis 715. More particularly, the shutter assembly 1200 includes side actuators 1230, which are similar in their architecture to the shutter-open and shutter close actuators 708 and 710, which move the shutter along the first axis 706. Both side actuators 1230 include a pair of compliant load beams 1232 positioned adjacent an opposing pair of compliant drive beams 1234, which together form an electrostatic actuator. The load beams 1232 of the side actuators 1230 couple to the shutter 702 via folded beams 1214. The dual compliant beam electrostatic actuators that form the shutter open actuator 708, the shutter close actuator 710, and the two side actuators 1230 tend to require lower voltage to actuate than the side electrodes used in the shutter assemblies 700, 800, 1000 and 1100, shown in FIGS. 7A-7D, 8A-8C, 10A-10C and 11A-11C, respectively. However, they take up additional space, limiting the aperture ratio and/or resolution of the display.

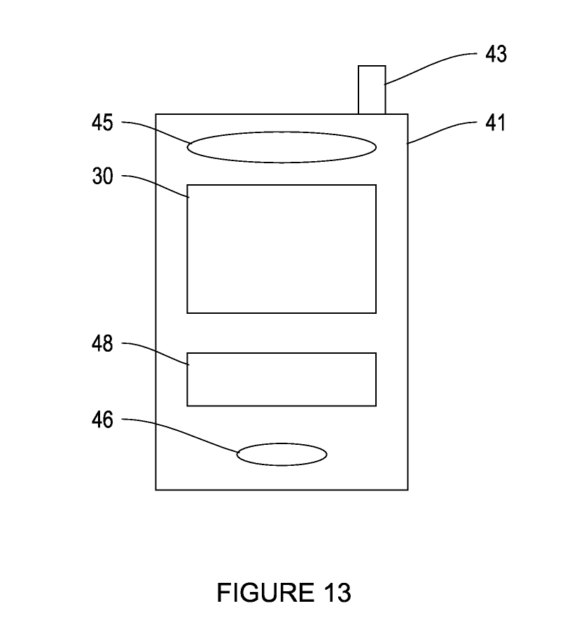

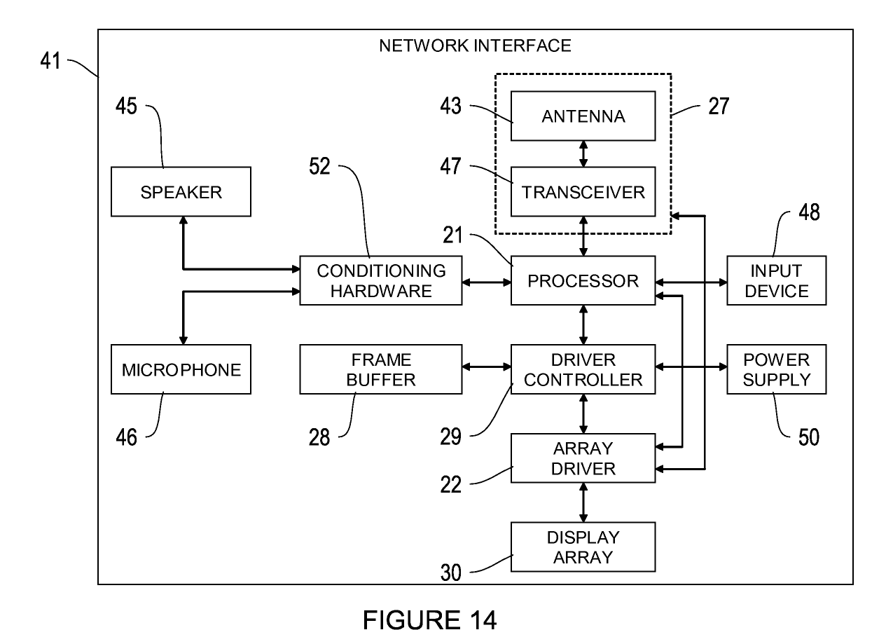

FIGS. 13 and 14 show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 13. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and grayscale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements, such as array of display elements 150 depicted in FIG. 1B). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a substrate;
a shutter, positioned adjacent the substrate, and configured to selectively obstruct an optical path through the substrate;
a first actuator mechanically coupled to a first end of the shutter for moving the shutter in a first direction along a first axis in a plane substantially parallel to a plane defined by the substrate, thereby moving the shutter from a first state to a second state; and
a second actuator positioned adjacent the shutter and configured to move the shutter in a second direction along a second axis, wherein the second axis is substantially orthogonal to the first axis and also is within a plane substantially parallel to the plane defined by the substrate, thereby moving the shutter into a third state.

2. The apparatus of claim 1, further comprising a third actuator mechanically coupled to the shutter for moving the shutter in a third direction opposite the first direction along the first axis, thereby moving the shutter into the first state.

3. The apparatus of claim 1, further comprising a spring mechanically coupled to the shutter for applying a restoring force to the shutter in a third direction opposite the first direction along the first axis, for moving the shutter back into the first state.

4. The apparatus of claim 1, wherein the second actuator includes an electrode, spaced apart from and mechanically separated from the shutter.

5. The apparatus of claim 4, further comprising a third actuator including an electrode spaced apart from and mechanically separated from the shutter on a side of the shutter opposite the second actuator for moving the shutter into a fourth state.

6. The apparatus of claim 5, wherein the electrode of the second actuator spaced apart from the shutter is spaced a first distance from the shutter and the electrode of the third actuator spaced apart from the shutter is spaced a second distance from the shutter.

7. The apparatus of claim 1, wherein the first state includes a light transmissive state, the second state includes a light blocking state in which the shutter obstructs the optical path; and the third state includes a partially light transmissive state in which the shutter only partially obstructs the optical path.

8. The apparatus of claim 7, wherein in the partially light transmissive state, the shutter blocks one of about 25%, about 33%, or about 50% of the light in the optical path.

9. The apparatus of claim 1, wherein the first actuator is coupled to the shutter by a compliant beam that includes an expandable portion.

10. The apparatus of claim 1, wherein the shutter includes at least one surface perpendicular to the plane of the substrate.

11. The apparatus of claim 1, wherein the surface of the shutter perpendicular to the plane of the substrate forms a side of the perimeter of the shutter, and the shutter serves as an electrode of the second actuator.

12. The apparatus of claim 1, wherein the shutter, the first actuator, and the second actuator form a portion of a display element, the apparatus further including:
a display including an array of display elements;
a processor that is configured to communicate with the display, the processor being configured to process image data; and
a memory device that is configured to communicate with the processor.

13. The apparatus of claim 12, further comprising:
a driver circuit configured to send at least one signal to the display; and wherein
the controller further configured to send at least a portion of the image data to the driver circuit.

14. The apparatus of claim 12, further comprising:
an image source module configured to send the image data to the processor, wherein the image source module comprises at least one of a receiver, transceiver, and transmitter.

15. The apparatus of claim 12, further comprising:
an input device configured to receive input data and to communicate the input data to the processor.

16. An apparatus comprising:
a substrate;
means for selectively obstructing an optical path through the substrate;
means for moving the light obstructing means in a first direction along a first axis in a plane substantially parallel to a plane defined by the substrate, thereby moving the light obstructing means from a first state to a second state; and
means for moving the light obstructing means in a second direction along a second axis, wherein the second axis is substantially orthogonal to the first axis, thereby moving the light obstructing means into a third state.

17. The apparatus of claim 16, further comprising a means for moving the shutter in a third direction opposite the first direction along the first axis, for moving the light obstructing means back into the first state.

18. The apparatus of claim 16, further comprising a restoring means for applying a restoring force to the light obstructing means in a third direction opposite the first direction along the first axis, thereby moving the light obstructing means into the first state.

19. The apparatus of claim 16, further comprising means for moving the light obstructing means into a fourth state.

20. The apparatus of claim 19, wherein the third and fourth states include distinct partially light obstructing states.
